(19) United States
(12) Patent Application Publication
(10) Pub. No.: US 2016/0370081 A1
(43) Pub. Date: Dec. 22, 2016

(54) REFRIGERATOR AND METHOD OF MANUFACTURING ICE MAKER THEREFOR

(71) Applicant: Dongbu Daewoo Electronics Corporation, Seoul (KR)

(72) Inventor: Sung Jin YANG, Seoul (KR)

(21) Appl. No.: 14/840,031

(22) Filed: Aug. 30, 2015

(30) Foreign Application Priority Data
Jun. 17, 2015 (KR) 10-2015-0086162

(51) Int. Cl. F25C 5/18; B23P 15/26; F25C 1/04

(52) U.S. Cl. CPC F25C 5/187; F25C 1/04; B23P 15/26

(57) ABSTRACT

According to an embodiment, an ice maker comprising: a main body having a cooling space supplied with the cold air generated by a cooling module; an ice making assembly comprising an ice tray arranged in the cooling space to generate ice, a cold air guide module disposed at a lower side of the ice tray and configured to guide the cold air supplied from the cooling module to the lower side of the ice tray, and a rotation module configured for rotating at least one of the ice tray and rotating an ejector for ejecting the ice from the ice tray; an ice bucket disposed at a lower side of the ice making assembly configured to receive the ice from the ice tray; and a full ice detection module configured for detecting whether the ice bucket is full of the ice.

### RELATED APPLICATION

This application claims priority to Korean Patent Application No. 10-2015-0086162, filed Jun. 17, 2015, hereby incorporated by reference in its entirety.

### FIELD

Embodiments of the present invention generally relate to a refrigerator and a method of manufacturing an ice maker therefor.

### BACKGROUND

A refrigerator is an appliance for storing food at low temperature, and may store food in a frozen or refrigerated state according to the type of food.

The interior of the refrigerator is cooled by continuously supplied cold air, and the cold air is generated through heat exchange with refrigerant by a refrigeration cycle performing a compression-condensation-expansion-evaporation process. The cold air supplied into the refrigerator is evenly transferred to the interior of the refrigerator by convection and thus the foods in the refrigerator may be maintained at a desired temperature.

The refrigerator typically has a rectangular main body which is open at a front surface thereof. The main body may have a refrigerating chamber and a freezing chamber therein. The front surface of the main body may be disposed with a refrigerating chamber door and a freezing chamber door, for selectively opening a portion of the refrigerator. The refrigerator may include a plurality of drawers, shelves, and storage boxes, etc., in order to optimally store various foods in an internal storage space of the refrigerator.

Conventionally, a top-mount type refrigerator, in which a freezing chamber is located in the upper portion and a refrigerating chamber is located in the lower portion has been used. In recent years, a bottom-freezer type refrigerator, in which a freezing chamber is located in the lower portion, has been also developed in order to increase user convenience.

The bottom-freezer type refrigerator has an advantage in that it is convenient for a user to frequently utilize a refrigerating chamber since it is located in the upper portion and the relatively less used freezing chamber is located in the lower portion. However, the bottom-freezer type refrigerator is inconvenient for ice access in the freezing chamber because the user needs to bend over to remove ice.

In order to resolve this problem, another bottom-freezer type refrigerator in which a dispenser for getting ice is disposed in the refrigerating chamber door located at the upper portion of the refrigerator has been recently developed. In this case, an ice maker may be disposed in the refrigerating chamber door or within the refrigerating chamber.

The ice maker may include an ice making assembly which generates ice and includes an ice tray, an ice bucket which stores the generated ice, and a transfer assembly which transfers the ice stored in the ice bucket to a dispenser.

Specifically, the ice made by the ice making assembly may be dropped into, and be collected in, the ice bucket located beneath the ice tray. The conventional ice maker includes a detection lever, a sensor, or the like capable of detecting whether or not the amount of ice collected in the ice bucket exceeds a predetermined amount. The ice maker may be controlled such that the operation of the ice maker is stopped when the amount of ice exceeds the predetermined amount.

However, since the conventional detection lever (or sensor) has a very limited ability to detect ice, there is a problem in that the amount of ice collected in the ice bucket is not accurately detected.

In addition, the sensor is mounted to the ice maker equipped with a plurality of components in a small space, and the ice maker is complicated to manufacture.

### SUMMARY

Therefore, embodiments of the present invention have been made in view of the above problems, and it is an object of the present invention to provide an ice maker for a refrigerator and a method of manufacturing the same, capable of accurately detecting whether or not an ice bucket is full of ice.

It is another object of the present invention to provide an ice maker for a refrigerator and a method of manufacturing the same, in which a full ice detection module is readily mounted to an ice maker.

According to an embodiment, a refrigerator comprising: a case having a food storage space; a cooling module configured for generating cold air and comprising a compressor, a condenser, an expansion valve, and an evaporator; a door disposed on the case to shield the food storage space; and an ice maker disposed in at least one of the food storage space and the door, wherein the ice maker comprises: a main body having a cooling space supplied with the cold air generated by the cooling module; an ice making assembly comprising an ice tray arranged in the cooling space to generate ice, a cold air guide section disposed at a lower side of the ice tray and configured to guide the cold air supplied from the cooling section to the lower side of the ice tray, and a rotation module configured for rotating at least one of the ice tray and an ejector for ejecting the ice from the ice tray; an ice bucket disposed at a lower portion of the ice making assembly and configured to receive the ice (e.g., dropped) from the ice tray; and a full ice detection module configured for detecting whether or not the ice bucket is full of the ice, and wherein the full ice detection module comprises: a first sensor coupled to a lower portion of the rotation module or a lower portion of the cold air guide module and configured to emit light; at least one reflective element coupled to the lower portion of the rotation module or the lower portion of the cold air guide module and configured to reflect the light emitted from the first sensor; and a second sensor mounted to the lower portion of the rotation module or the lower portion of the cold air guide module and configured to allow detection of the light reflected by the reflective element.

Further, wherein, the light emitted from the first sensor is reflected (e.g., and refracted) through the reflective element and is then received by the second sensor.

Further, wherein, the first sensor is inserted into a first mounting portion disposed in the lower portion of the rotation module, and the second sensor is inserted into a second mounting portion disposed in the lower portion of the cold air guide module.

Further, wherein the first sensor and the reflective element are mounted at diagonal points on a rectangular portion of a plane formed by a back surface of the ice tray.

Further, wherein the second sensor and the reflective element are mounted at diagonal points on the rectangular portion of the plane formed by the back surface of the ice tray.

Further, wherein when the reflective element is configured with an odd number of reflective elements, the first and second sensors are mounted to one side along a longitudinal direction of the ice tray.

Further, wherein when the reflective element is configured with an even number of reflective elements, the first and second sensors are mounted on opposite sides along the longitudinal direction of the ice tray.

Further, wherein the light emitted from the first sensor moves along a zigzag path between the first sensor, the reflective element, and the second sensor.

Further, wherein when the reflective element is configured as a plurality of reflective elements mounted to the rotation module and the cold air guide module, one reflective element and the other reflective elements are mounted at diagonal points of a rectangular plane formed by a back surface of the ice tray.

Further, wherein the reflective member is mounted through a third mounting portion disposed in the cold air guide module, and the third mounting portion has a slot into which the reflective element is slidably inserted.

Further, wherein the cold air is supplied into the cooling space through a discharge duct, and the cold air guide module extends from at least one surface of the discharge duct.

Further, wherein the cold air guide module comprises: a first cold air guide element extending from an upper surface of the discharge duct; and a second cold air guide element extending from a lower surface of the discharge duct, and wherein the second cold air guide element is spaced apart from a back surface of the ice tray, so that a cold air movement passage is formed between the back surface of the ice tray and an upper surface of the second cold air guide element.

According to an embodiment, a method of manufacturing an ice maker for a refrigerator, the method comprising: manufacturing an ice maker comprising an ice making assembly, an ice bucket, and a transfer assembly; mounting a first sensor, a reflective element, and a second sensor of a full ice detection module, for detecting whether the ice bucket is full of ice, to a lower portion of a rotation module of the ice making assembly and to a lower portion of a cold air guide module of the ice making assembly; adjusting positions of the first sensor, the reflective element, and the second sensor mounted to the rotation module and the cold air guide module when the first sensor, the reflective element, and the second sensor are optically (e.g., operatively) coupled to each other; and assembling the transfer assembly to one side of the ice bucket and assembling the ice making assembly to an upper side of the ice bucket.

Further, wherein an ice tray configured for accommodation of water or ice is disposed at an upper side of the cold air guide module; and the first sensor, the reflective element, and the second sensor are mounted in a zigzag arrangement at diagonal points of a rectangular portion of a plane formed by a back surface of the ice tray.

Further, wherein when the reflective element is configured with an odd number of reflective elements, the first and second sensors are coupled to one side along a longitudinal direction of the ice tray.

Further, wherein, when the reflective elements is configured with an even number of reflective elements, the first and second sensors are mounted to opposite sides along the longitudinal direction of the ice tray.

Further, wherein, when the reflective element is configured with a plurality of reflective elements mounted to the rotation module and the cold air guide module, one reflective element and the other reflective elements are mounted in a zigzag arrangement at diagonal points of a rectangular portion of a plane formed by a back surface of the ice tray.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating an exemplary ice maker is disposed in a refrigerator according to an embodiment of the present invention;

FIG. 2 is a side cross-sectional view illustrating the ice maker in FIG. 1;

FIG. 3 is an exploded perspective view illustrating the ice maker in FIG. 2;

FIG. 4 is a planar cross-sectional view conceptually illustrating the ice maker in FIG. 2;

FIG. 5 is a view conceptually illustrating a state in which a plurality of reflective elements is disposed in the ice maker in FIG. 4;

FIG. 6 is a view schematically illustrating a reflective element mounted on a back surface of a cold air guide module of the ice maker in FIG. 2; and

FIG. 7 is an exemplary flowchart illustrating a method of manufacturing the ice maker according to an embodiment of the present invention.

### DETAILED DESCRIPTION OF THE EMBODIMENTS

Exemplary embodiments of the present invention will be described below in detail with reference to the accompanying drawings. In certain embodiments, detailed descriptions of relevant constructions or functions well known in the art may be omitted to avoid obscuring appreciation of the disclosure.

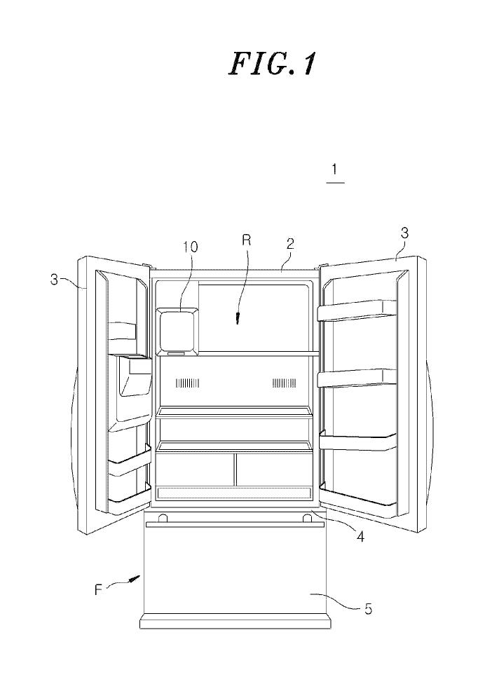

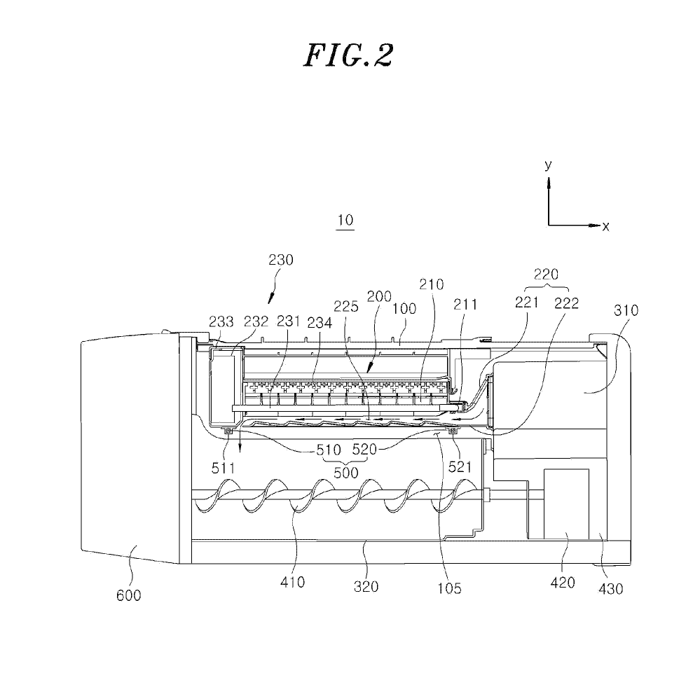

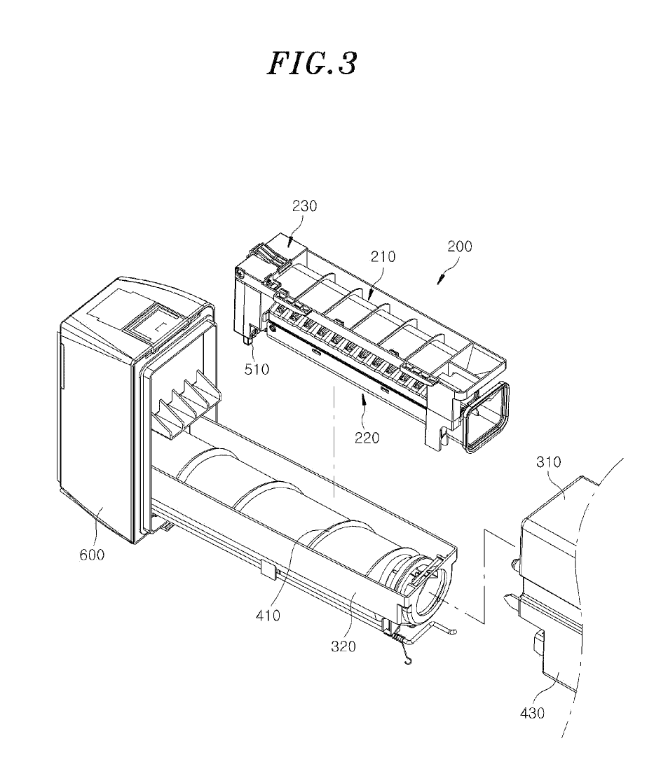

FIG. 1 is a view illustrating a refrigerator according to an embodiment of the present invention. FIG. 2 is a side cross-sectional view illustrating an ice maker in FIG. 1. FIG. 3 is an exploded perspective view illustrating the ice maker in FIG. 2.

Referring to FIGS. 1 to 3, the refrigerator 1 according to an embodiment may include a case 2 defining an external structure and/or appearance thereof, a barrier 4 which divides a food storage space and partitioning the case 2 into an upper refrigerating chamber R and a lower freezing chamber F, refrigerating chamber doors 3 disposed at both front edges of the case 2 to selectively open and close the refrigerating chamber R by rotation thereof, and a freezing chamber door 5 which functions as a front opening portion of the freezing chamber F. Although an ice maker 10 is illustrated as being disposed at one side of an upper portion of the refrigerating chamber R in the embodiment, this is by way of example only. Alternatively, the ice maker 10 may be installed at a different position in the refrigerating chamber R or in a different place such as the refrigerating chamber door 3.

The ice maker 10 disposed in the refrigerator 1 is an ice maker capable of detecting whether or not an ice bucket 320 is full of ice. The ice maker 10 may include a main body 100, a cooling section (not shown), an ice making assembly 200, an ice bucket 320, a transfer assembly 400, and a full ice detection section 500.

The main body 100 of the ice maker 10 may have a cooling space 105 in which ice may be generated. The ice making assembly 200 may be disposed at an upper side in the cooling space 105 and the ice bucket 320 may be arranged at a lower side of the ice making assembly 200.

The cooling module functions to generate cold air and supply the generated cold air to an ice tray 210. The cooling module may include a compressor, a condenser, an expansion valve, an evaporator, etc. which performs a cooling cycle. The cooling module generates cold air by exchanging heat between a refrigerant and air as is well-known. Cold air may be supplied to the ice tray 210 through a discharge duct 310 and a cold air guide module 220 by a blower or the like.

The ice making assembly 200 includes an ice tray 210 which receives water, a cold air guide module 220 which guides the flow of cold air such that the cold air supplied from the cooling module moves along a back surface of the ice tray 210, and a rotation module 230 which rotates the ice tray 210 to drop the ice into the ice bucket 320.

The ice tray 210 provides a space in which water supplied from a water supply pipe (not shown) or the like is cooled to produce ice, and has a plurality of ice forming spaces formed on an upper surface thereof to accommodate water. The forming spaces may have various shapes according to the shape of ice to be made, and the number of forming spaces may vary.

The ice tray 210 may be made of metal having high thermal conductivity, e.g., aluminum. The ice tray 210 may improve a heat exchange rate between water and cold air due to high thermal conductivity. Consequently, the ice tray 210 may serve as a type of heat exchanger. Although not illustrated, the back surface of the ice tray 210 may be provided with cooling ribs or the like for increasing surface area contact with the cold air.

The cold air guide module 220 functions to guide the cold air supplied from the cooling module to the lower side of the ice tray 210. The cold air guide module 220 may be coupled to the discharge duct 310 as a passage through which the cold air is supplied from the cooling module. The cold air guide module 220 may include cold air guide elements 221 and 222 coupled to at least one surface of the discharge duct 310, and may include a first cold air guide element 221 extending from an upper surface of the discharge duct 310 and a second cold air guide element 222 extending from a lower surface of the discharge duct 310.

The first cold air guide element 221 may be coupled between the upper surface of the discharge duct 310 and a bracket 221 to which the ice tray 210 is mounted. The second cold air guide element 222 may extend from the lower surface of the discharge duct 310 and be spaced apart from the back surface of the ice tray 210. Thus, a cold air passage 225 for cold air flow may be formed between the back surface of the ice tray 210 and an upper surface of the second cold air guide element 222.

The cold air guided by the cold air guide elements 221 and 222 may flow toward the back surface of the ice tray 210, and may exchange heat with the ice tray 210 so that the water present in the ice tray 210 is transformed into ice.

The ice made in the above manner may be dropped into the ice bucket 320 disposed beneath the ice tray 210 by the rotation module 230. Specifically, the upper surface of the ice tray 210 may be turned toward the ice bucket 320 by rotation of a rotary shaft 234, and the ice tray 210 may be twisted (e.g., distorted) by contact with a fixed element (not shown) when rotating beyond a specific angle. Consequently, through the twisting of the ice tray 210, ice in the ice tray 210 may be dropped into the ice bucket 320.

In addition, a plurality of ejectors (not shown) may be disposed in the rotary shaft 234 so ice is ejected from the ice tray 210 by rotation of the ejectors, without the rotation of the ice tray 210. The rotary shaft 234 may be driven by an ice maker driving module 232, and the ice maker driving module 232 may be coupled in the ice making space 105 by an ice maker fixture 233.

Moreover, the ice tray 210 may be equipped with a deicing heater 231 which heats a surface of the ice tray 210 during or before rotation of the rotary shaft 234. Ice may be separated from the ice tray 210 in a manner that melts the surface of the ice in the ice tray 210 with heat from the deicing heater 231.

The transfer assembly 400 transfers ice toward an ice discharge module 600, and may include an auger 410 and an auger motor 420. The auger 410 may be a rotatable element having blades in a screw or spiral form, and is rotated by the auger motor 420. The auger 410 may be disposed in the ice bucket 320. Ice collected in the ice bucket 320 may be inserted between the blades of the auger 410 to be transferred toward the ice discharge module 600 by rotation of the auger 410. The auger motor 420 may be disposed in an auger motor housing 430.

The ice discharge module 600 may be connected to a dispenser (not shown) disposed in one of the refrigerating chamber doors 3, and the ice transferred by the transfer assembly 400 may be supplied to a user through the dispenser according to an activation thereof by the user. Although not illustrated, the ice discharge module 600 may have a cutting element for cutting ice into a predetermined size.

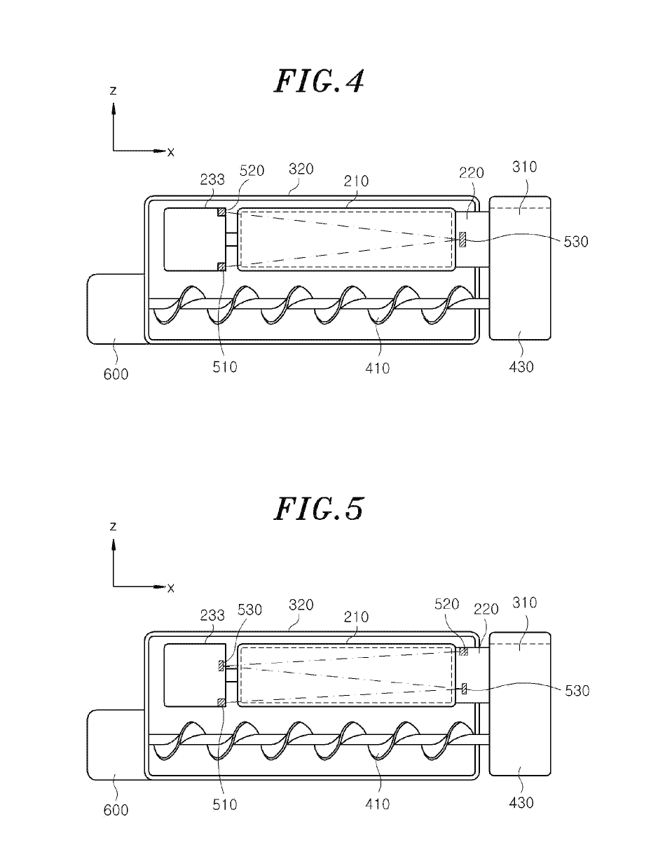

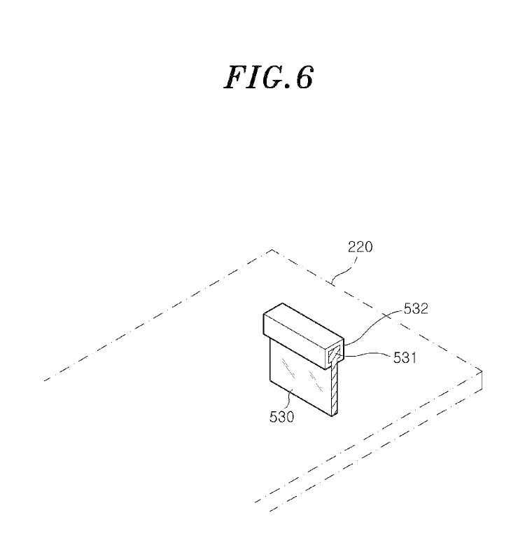

FIG. 4 is a planar cross-sectional view conceptually illustrating the ice maker in FIG. 2. FIG. 5 is a view conceptually illustrating a plurality of reflective elements disposed in the ice maker in FIG. 4. FIG. 6 is a view schematically illustrating a reflective element on mounted on a back surface of a cold air guide module of the ice maker in FIG. 2.

Referring to FIGS. 4 to 6, the full ice detection module 500 detects that ice is collected in the ice bucket 320 beyond a certain extent, that is, detects whether the ice bucket 320 is full of ice. The full ice detection module 500 may include a pair of first and second sensors 510 and 520 and a reflective element 530, which are mounted to the rotation module 230 and the cold air guide module 220, respectively. The sensors 510 and 520 may be photo sensors such as infrared sensors, and may be configured as a light-emitting sensor and a light-receiving sensor for instance.

The light-emitting sensor is a sensor configured for emitting light which may be blocked by ice, and the light-receiving sensor is a sensor configured for detecting light. When light emitted from the light-emitting sensor is not received by the light-receiving sensor, it may be determined that a blocking material, namely ice, is present in a path of light. In an exemplary embodiment, the first sensor 510 is a light-emitting sensor and the second sensor 520 is a light-receiving sensor which are described below.

The heights (e.g., y-axis coordinates) at which the first and second sensors 510 and 520 and the reflective element 530 of the full ice detection module 500 are mounted to the rotation module 230 and the cold air guide module 220 vary according to the limited amount of ice which may be accommodated in the ice bucket 320 (hereinafter, referred to as the “predetermined limited capacity”). The first and second sensors 510 and 520 and the reflective element 530 of the full ice detection module 500 may be coupled to the rotation module 230 and the cold air guide module 220 at the relevant heights.

The reflective element 530 may include a reflective material for reflecting light emitted from the first sensor 510, and may be an element having a flat reflective surface in order to provide uniform reflection. The light emitted from the first sensor 510 may be received by the second sensor 520 via the reflective element 530.

The reflective elements 530 may be designed as illustrated in FIG. 4, and there may also be multiple reflective elements.

When the reflective member 530 is configured with an odd number of reflective members, the first and second sensors 510 and 520 are mounted to one side along a longitudinal direction of the ice tray 210. When the reflective member 530 is configured with an even number of reflective members as illustrated in FIG. 5, the first and second sensors 510 and 520 are mounted to opposite sides along the longitudinal direction of the ice tray 210. That is, light emitted from the first sensor 510 may sequentially pass through at least one reflective element 530 and the second sensor 520 along a zigzag path (e.g., as shown by the dotted line in FIG. 5).

At least one of the first and second sensors 510 and 520 and the reflective element 530 may be mounted to a lower portion of the ice maker fixture 233 of the rotation module 230. The other sensor or reflective element may be mounted to the other side lower portion of the second guide element 222. In this case, the first and second sensors 510 and 520 may be mounted to the rotation module 230 and the cold air guide module 220 through first and second mounting portions 511 and 521, each having respective grooves into which the first and second sensors 510 and 520 are inserted therein.

The reflective element 530 may be coupled to the rotation module 230 or the cold air guide module 220, or may be mounted through a third mounting portion 532 disposed in the rotation module 230 or the cold air guide module 220. The third mounting portion 532 may have a slot into which the reflective element 530 is slidably inserted, and the reflective element 530 may have a protrusion 531 which is slidably inserted into and fixed by a supporting, gripping, or friction fit of the slot.

The first sensor 510 and the reflective element 530 are mounted at diagonal points on a rectangular portion of a plane (e.g., x-z plane) formed by the back surface of the ice tray 210. In addition, the reflective element 530 and the second sensor 520 may be mounted at diagonal points the rectangular portion of a plane (e.g., x-z plane) formed by the back surface of the ice tray 210. That is, the first and second sensors 510 and 520 and the reflective element 530 are mounted at different points on the z-axis.

In addition, since a mechanical full ice detection structure, such as a detection lever, is replaced with the full ice detection module 500 according to the embodiment, the number of parts and assembly processes may be reduced and thus manufacturing costs may be reduced.

Furthermore, since the detection region for detecting whether the ice bucket is full of ice is enlarged, factors contributing to malfunction due to full ice detection errors are reduced, and thus the ice maker has improved reliability.

Hereinafter, the operation and results or functions of the ice maker according to an embodiment of the present invention will be described.

In the ice maker 10 according to an embodiment, cold air generated through the compressor, the condenser, the expansion valve, and the evaporator may be supplied to the cooling space 105 via the discharge duct 310. The cold air freezes water placed in the ice tray 210 disposed in the cooling space 105. In this case, since the cold air guide module 220 is connected to the discharge duct 310 and extending therefrom, the cold air discharged from the discharge duct 310 moves along the cold air guide module 220.

Referring to FIG. 2, the cold air enters between the first guide element 221 and the second guide element 222 and then moves along the cold air passage 225 formed between the back surface of the ice tray 210 and the second guide element 222. The cold air exchanges heat with the back surface of the ice tray 210 while moving along the back surface of the ice tray 210, and cools water in the ice tray 210 so as to form ice. The ice made in the ice tray 210 may be dropped downward by rotation of the rotary shaft 234 and is collected in the ice bucket 320 arranged beneath the ice tray 210.

As ice is generated, the amount of ice collected in the ice bucket 320 may exceed a predetermined limited capacity of the ice bucket 320. In this case, the full ice detection module 500 detects whether or not the amount of ice collected in the ice bucket 320 exceeds the predetermined limited capacity of the ice bucket 320.

Referring to FIG. 5, the first sensor 510 constantly or periodically emits light, and the light emitted from the first sensor 510 reaches the reflective element 530 located on the diagonal path. The light reaching the reflective element 530 is reflected (e.g., and refracted) by the reflective element 530 and travels to another reflective member 530 or is received by the second sensor 520 which is located on the diagonal path in the opposite direction. That is, the light emitted from the first sensor 510 sequentially passes through at least one reflective member 530 and the second sensor 520 along the zigzag path.

When the light passing through the diagonal path is received by the second sensor 520, the amount of ice collected in the ice bucket 320 may be determined to be less than the predetermined limited capacity of the ice bucket 320.

When ice is accumulates in the ice bucket 320 and exceeds a predetermined height, e.g., to the detection height of the full ice detection module 500, light emitted from the first sensor 510 hits the ice and the light is not received by the second sensor 520. Accordingly, a control unit (not shown) determines whether the ice bucket 320 is full of ice. Then, the control unit stops the driving of the rotation module 230 and stops and/or pauses the operation of the components for manufacturing ice.

The reflective element 530 is disposed between the first and second sensors 510 and 520, thereby enabling the path of light emitted from the first sensor 510 to reach the second sensor. Consequently, the region in which the full ice detection module 500 can detect whether the ice bucket is full of ice is enlarged.

In addition, the range of the detection region may be adjusted by adding additional reflective elements. Since the detection region can be enlarged using one or more low-priced reflective elements instead of a relatively expensive sensor, thereby reducing manufacturing cost.

In addition, when the full ice detection section 500 is disposed on the back surface of the cold air guide module 220, the full ice detection section 500 effectively detects ice dropped from the ice tray 210 since the lower region of the ice tray 210 overlaps the lower region of the cold air guide section 220.

Hereinafter, a method of manufacturing the ice maker according to an embodiment of the present invention will be described.

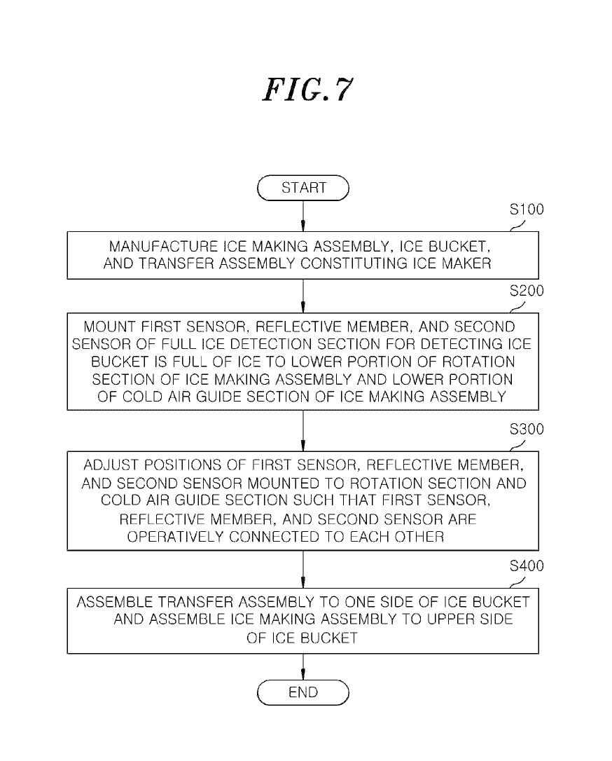

FIG. 7 is a flowchart illustrating an exemplary method of manufacturing the ice maker according to an embodiment of the present invention.

Referring to FIGS. 1 to 7, the above-mentioned ice maker 10 comprises the ice making assembly 200, the ice bucket 320, and the transfer assembly 400. In order to manufacture the ice maker 10 according to an embodiment, the ice making assembly 200, the ice bucket 320, and the transfer assembly 400, which constitute the ice maker 10, are individually manufactured in accordance with well-known manners (S100). The first sensor 510, the reflective member 530, and the second sensor 520 of the full ice detection module 500 (for detecting whether the ice bucket 320 is full of ice) are mounted to the lower portion of the rotation module 230 of the ice making assembly 200 and the lower portion of the cold air guide section 220 of the ice making assembly 200 (S200).

In this case, the first sensor 510 may be inserted into a groove of the first mounting portion 511, and the second sensor 520 may be inserted into the groove of the second mounting portion 521. The reflective element 530 may be slidably inserted into the slot of the third mounting portion 532.

The first sensor 510, the reflective element 530, and the second sensor 520 are mounted in a zigzag arrangement at the diagonal points of a rectangular portion of a plane formed by the back surface of the ice tray 210. The positions of the first sensor 510, the reflective member 530, and the second sensor 520 mounted to the rotation module 230 and the cold air guide module 220 are adjusted such that the first sensor 510, the reflective element 530, and the second sensor 520 are optically and/or operatively coupled to each other (S300). That is, the positions of the first sensor 510, the reflective element 530, and the second sensor 520 are adjusted such that light emitted from the first sensor 510 is reflected (e.g., and refracted) by the reflective element 530 and is then received by the second sensor 520.

In this case, when the reflective member 530 is configured with an odd number of reflective members, the first and second sensors 510 and 520 are mounted to one side along a longitudinal direction of the ice tray 210. When the reflective member 530 is configured with an even number of reflective members, the first and second sensors 510 and 520 are mounted to opposite sides along the longitudinal direction of the ice tray 210. In addition, when a plurality of reflective members 530 is disposed on the rotation section 230 and the cold air guide section 220, one reflective member 530 and the other reflective members 530 are mounted in a zigzag arrangement at the diagonal points of a rectangular portion of a plane formed by the back surface of the ice tray 210.

When the position adjustment of the first sensor 510, the reflective element 530, and the second sensor 520 is completed, the transfer assembly 400 is assembled to one side of the ice bucket 320 and the ice making assembly 200 may be assembled to the upper side of the ice bucket 320 (S400). The ice maker 10 manufacture may be completed by additionally assembling the main body 100, the ice discharge module 600, etc., to form the ice maker 10.

The first sensor 510, the reflective element 530, and the second sensor 520 of the full ice detection module 500 according to an embodiment are mounted to the ice making assembly 200 manufactured as a single assembly. Thus, the full ice detection module 500 may be mounted to the ice making assembly 200 before the assemblies forming the ice maker 10 are assembled to each other. That is, since the full ice detection section 500 components including the pair of sensors 510 and 520 and the reflective element 530 are intended to be optically and/or operatively coupled to each other and mounted to the single assembly, the full ice detection section 500 can be easily mounted without interference with the other assemblies.

In addition, the process of adjusting the positions of the first sensor 510, the reflective element 530, and the second sensor 520 in order to optically and/or operatively interconnect the first and second sensors 510 and 520 and the reflective element 530 as light-emitting and light-receiving sensors and a reflective member can be easily performed without interfering with other portions of the ice maker.

In accordance with exemplary embodiments of the present invention, it is possible to provide a refrigerator including an ice maker capable of accurately detecting whether or not an ice bucket is full of ice.

In addition, it is possible to provide a method of manufacturing the ice maker for the refrigerator, in which a full ice detection module is easily mounted to the ice maker.

Although the preferred embodiments of the present invention have been disclosed for illustrative purposes, it will be apparent to those skilled in the art that various changes and modifications can be made without departing from the spirit and scope of the invention as defined in the following claims. More particularly, various variations and modifications are possible in constituent elements of the embodiments. In addition, it is to be understood that differences relevant to the variations and modifications fall within the spirit and scope of the present disclosure defined in the appended claims.

What is claimed is:

1. A refrigerator comprising:
a case comprising a food storage space;
a cooling module comprising a compressor, a condenser, an expansion valve, and an evaporator and configured to generate cold air;
a door disposed on the case to shield the food storage space; and
an ice maker installed in at least one of the food storage space and the door,
wherein the ice maker comprises:
a main body having a cooling space for receiving the cold air generated by the cooling module;
an ice making assembly comprising: an ice tray disposed in the cooling space to generate ice, a cold air guide module disposed at a lower side of the ice tray and configured to guide the cold air supplied from the cooling module to the lower side of the ice tray, and a rotation module configured for rotating at least one of the ice tray and an ejector for ejecting the ice from the ice tray;
an ice bucket disposed at a lower side of the ice making assembly and configured to receive the ice from the ice tray; and
a full ice detection module configured for detecting whether the ice bucket is full of the ice, and
wherein the full ice detection module comprises:
a first sensor coupled to at least one of a lower portion of the rotation module and a lower portion of the cold air guide module and configured to emit light;
at least one reflective element coupled to at least the lower portion of the rotation module and the lower portion of the cold air guide module and configured to reflect the light emitted from the first sensor; and
a second sensor coupled to at least one of the lower portion of the rotation module and the lower portion of the cold air guide module to allow detection of the light reflected by the reflective element.

2. The refrigerator according to claim 1, wherein the light emitted from the first sensor is refracted through the reflective element and is then received by the second sensor.

3. The refrigerator according to claim 1, wherein the first sensor is inserted into a first mounting portion disposed in the lower portion of the rotation module, and the second sensor is inserted into a second mounting portion disposed in the lower portion of the cold air guide module.

4. The refrigerator according to claim 1, wherein the first sensor and the reflective element are coupled at diagonal points on a rectangular portion of a plane formed by a back surface of the ice tray.

5. The refrigerator according to claim 4, wherein the second sensor and the reflective element are coupled at diagonal points on the rectangular portion of the plane formed by the back surface of the ice tray.

6. The refrigerator according to claim 1, wherein when the reflective element is configured with an odd number of reflective elements, the first and second sensors are mounted to one side along a longitudinal direction of the ice tray.

7. The refrigerator according to claim 1, wherein when the reflective element is configured with an even number of reflective elements, the first and second sensors are mounted to opposite sides along a longitudinal direction of the ice tray.

8. The refrigerator according to claim 1, wherein the light emitted from the first sensor moves along a zigzag path between the first sensor, the reflective element, and the second sensor.

9. The refrigerator according to claim 1, wherein the reflective element is configured with a plurality of reflective members coupled to the rotation module and the cold air guide module, and wherein one reflective member and the other reflective members are mounted at diagonal points on a rectangular portion of plane formed by a back surface of the ice tray.

10. The refrigerator according to claim 1, wherein the reflective member is coupled through a third mounting portion disposed in the cold air guide module, and wherein the third mounting portion comprises a slot into which the reflective element can be slidably inserted.

11. The refrigerator according to claim 1, wherein the cold air is supplied into the cooling space through a discharge duct, and wherein the cold air guide module extends from at least one surface of the discharge duct.

12. The refrigerator according to claim 11, wherein the cold air guide module comprises:
a first cold air guide member extending from an upper surface of the discharge duct; and
a second cold air guide member extending from a lower surface of the discharge duct, and
wherein the second cold air guide member extends spaced apart from a back surface of the ice tray, wherein a cold air movement passage is formed between the back surface of the ice tray and an upper surface of the second cold air guide member.

13. A method of manufacturing an ice maker for a refrigerator, the method comprising:
manufacturing an ice making assembly, an ice bucket, and a transfer assembly forming an ice maker;
coupling a first sensor, a reflective member, and a second sensor of a full ice detection module, to a lower portion of a rotation module of the ice making assembly and a lower portion of a cold air guide module of the ice making assembly, wherein the full ice detection module is configured for detecting whether the ice bucket is full of ice;
adjusting positions of the first sensor, the reflective member, and the second sensor coupled to the rotation module and the cold air guide section to optically couple the first sensor, the reflective element, and the second sensor; and
assembling the transfer assembly to a side of the ice bucket and assembling the ice making assembly to an upper side of the ice bucket.

14. The method according to claim 13, further comprising:
disposing an ice tray for accommodating water or ice at an upper side of the cold air guide module; and
wherein the first sensor, the reflective element, and the second sensor are coupled in a zigzag arrangement at diagonal points on a rectangular portion of a plane formed by a back surface of the ice tray.

15. The method according to claim 14, wherein the reflective element is configured with an odd number of reflective elements and the first and second sensors are coupled to one side along a longitudinal direction of the ice tray.

16. The method according to claim 14, wherein the reflective element is configured with an even number of reflective elements and the first and second sensors are coupled to opposite sides along a longitudinal direction of the ice tray.

17. The method according to claim 13, wherein the reflective element is configured with a plurality of reflective members coupled to the rotation module and the cold air guide module, and wherein one reflective element and the other reflective elements are coupled in a zigzag arrangement at diagonal points on a rectangular portion of a plane formed by a back surface of the ice tray.

18. An apparatus comprising:
an ice bucket coupled to a side of an ice making assembly and configured to receive the ice from an ice tray; and
a full ice detection module configured for detecting the ice bucket being full, wherein the full ice detection module comprises:
a first sensor coupled to at least one of a lower portion of a rotation module and a lower portion of a cold air guide module and configured to emit light;
at least one reflective element coupled to the lower portion of the rotation module or the lower portion of the cold air guide module and configured to reflect the light emitted from the first sensor; and
a second sensor coupled to at least one of the lower portion of the rotation module and the lower portion of the cold air guide module to allow detection of the light reflected by the reflective element.
